(19) United States
(12) Patent Application Publication
(10) Pub. No.: US 2010/0006634 A1
(43) Pub. Date: Jan. 14, 2010

(54) PAPERBOARD RECEPTACLE HAVING A LOCKING TAB

(76) Inventor: Edward Vogel, Romulus, MI (US)

Correspondence Address: HOWARD & HOWARD ATTORNEYS PLLC, 450 West Fourth Street, Royal Oak, MI, 48067, US

(21) Appl. No.: 12/499,719

(22) Filed: Jul. 8, 2009

Related U.S. Application Data
(60) Provisional application No. 61/079,072, filed on Jul. 8, 2008.

(51) Int. Cl. B65D 5/24; B31B 17/00; B31D 5/04

(52) U.S. Cl. 229/187; 493/84; 428/12

(57) ABSTRACT

A sheet of foldable material and a receptacle assembled from the sheet of foldable material are provided. The sheet includes a pair of side wall panels and a pair of end wall panels disposed opposite to each other across a bottom panel. The sheet further comprises a pair of collapsible corner flap panels that are collapsible and foldable along a fold line. The corner flaps define a fold edge along the fold line after collapsing. A folding flap has a first end attached to the end wall panel and is folded over the corner flaps with the corner flaps disposed between the folding flap and the end wall after folding. The folding flap includes a locking tab on a portion thereof adjacent to the fold edge of at least one of the resulting corner flaps. The locking tab is insertable around the fold edge and between the corner flap and the end wall.

### RELATED APPLICATIONS

The subject patent application claims priority to, and all the benefits of, U.S. Provisional Patent Application Ser. No. 61/079,072 filed on Jul. 8, 2008.

### BACKGROUND OF THE INVENTION

1. Field of the Invention

The instant invention generally relates to a sheet of foldable material, a receptacle assembled from the sheet of foldable material, and a method of assembling a receptacle from the sheet of foldable material. More specifically, the instant invention relates to a sheet of foldable material that may be assembled into the receptacle with the sheet of foldable material containing a feature that inhibits unfolding of the receptacle once assembled.

2. Description of the Related Art

Paperboard receptacles are known in the art for many uses. The paperboard receptacles are generally assembled from a single sheet of paperboard, with the paperboard provided with fold lines, cuts, and/or perforations in a manner to allow the paperboard to be folded into the form of the paperboard receptacle.

A primary concern with the assembly of paperboard receptacles is prevention of unfolding due to stresses built up in the fold lines. Many paperboard receptacles require adhesives to remain intact without unfolding. However, other mechanisms have also been employed to prevent unfolding of the paperboard receptacles. For example, it is known to use mechanical features such as the locking tabs used in conjunction with slots in the paperboard and with the locking tabs inserted through the slots to prevent unfolding of the paperboard receptacles. It is also known to employ various flap configurations with the flaps interacting with each other to prevent the paperboard receptacles from unfolding.

In one specific example, paperboard receptacles are known that include a pair of side walls disposed opposite to each other and a pair of end walls also disposed opposite to each other and extending between the respective side walls to form the four walls of the box. Collapsible corner flaps adjoin each of the end walls to the side walls, with the corner flaps collapsed along a fold line and extending into the interior of the receptacle. A folding flap is attached at a first end thereof to the respective short wall of the paperboard receptacle. The folding flap includes a second end disposed opposite the first end and free from attachment to any other portion of the paperboard receptacle such that the folding flap is free to hinge about the attachment point to the respective short wall. The corner flaps are held against the short wall that is adjacent to the respective corner flaps, and the folding flap is folded over the corner flaps to prevent unfolding of the corner flaps. The side walls of the paperboard receptacle are provided with slots, and the folding flap contains tabs on the sides thereof, i.e., on the portions of the folding flap that are adjacent to the side walls. The tabs fit into the slots to hold the folding tabs in place and to prevent unfolding of the paperboard receptacle.

There are deficiencies with the aforementioned mechanism that relies upon slots in the side walls and tabs on the sides of the folding flap to prevent unfolding. For example, the interaction between the slots and the tabs on the folding flap may be insufficient to prevent unfolding of the paperboard receptacle under conditions in which the folding flap is subject to rotational force about the attachment point between the folding flap and the end wall. Further, it may be undesirable for the paperboard receptacle to include slots there under conditions in which the paperboard receptacle is intended to be used for retaining wet or moist contents. For example, if the paperboard receptacle is intended to be used as a cooler for retaining ice, slots in the side walls may enable moisture to enter an interior portion of the side walls and accelerate breakdown of the paperboard material.

In view of the foregoing, there remains an opportunity to provide a sheet of foldable material, and a receptacle assembled from the sheet of foldable material, that include a feature that inhibits unfolding of the receptacle once assembled without relying upon slots cut through the sheet foldable material to inhibit unfolding.

### SUMMARY OF THE INVENTION AND ADVANTAGES

The present invention provides a sheet of foldable material, a receptacle assembled from the sheet of foldable material, and a method of assembling the receptacle from the sheet of foldable material. The sheet of foldable material comprises a pair of side wall panels disposed opposite to each other across a bottom panel and a pair of end wall panels also disposed opposite to each other across the bottom panel. The side wall panels and the end wall panels are foldable into respective side walls and end walls of the receptacle. The resulting end walls, after folding, extend between the respective side walls to define an interior of the receptacle. The sheet of foldable material further comprises a pair of collapsible corner flap panels that adjoin one of the end wall panels to the side wall panels adjacent thereto. The corner flap panels are collapsible and foldable along a fold line. After collapsing and folding the corner flap panels, the resulting corner flaps extend toward each other into the interior of the receptacle. The corner flaps define a fold edge along the fold line after the corner flap panels are collapsed. The sheet of foldable material further comprises a folding flap having a first end and a second end. The first end of the folding flap is attached to the end wall panel and the second end of the folding flap is disposed opposite the first end. The second end of the folding panel is free from attachment to the end wall panels and side wall panels. In the receptacle, the corner flaps are held against the end wall that is adjacent to the respective corner flaps. The folding flap is folded over the corner flaps with the corner flaps disposed between the folding flap and the end wall after folding the folding flap. The folding flap includes a locking tab on a portion thereof. Upon folding of the corner flap panels, side wall panels, and end wall panels, the locking tab is adjacent to the fold edge of at least one of the resulting corner flaps. The locking tab is insertable around the fold edge and between the corner flap and the end wall.

Due to the location of the locking tab, and the insertable nature of the locking tab around the fold edge and between the corner flap and the end wall, the locking tab inhibits unfolding of the receptacle once assembled without relying upon slots cut through the sheet of foldable material (although it is to be appreciated that the instant invention is not limited to a receptacle that is free from slots cut through the sheet of foldable material). The locking tabs may be particularly useful for receptacles formed from sheets of fibrous material, such as a sheet of corrugated paperboard, when the receptacles are intended to be used for retaining wet or moist contents such as ice. The locking tabs further provide a robust alternative or supplement to a mechanism that relies upon slots in the side walls and tabs on the sides of the folding flap to prevent unfolding.

### DESCRIPTION OF THE DRAWINGS

Other objects, features, and advantages of the present invention will be readily appreciated as the same becomes better understood while reading the subsequent description taken in conjunction with the accompanying drawings wherein:

FIG. 1 a perspective view of a receptacle in accordance with the instant invention;

FIG. 2 is a pre-assembly view of one embodiment of a sheet of foldable material for assembling into a receptacle in accordance with the instant invention;

FIG. 3 is a partially disassembled view of a portion of a receptacle formed from the sheet of FIG. 2, focusing on a locking tab thereof;

FIG. 4 is an inside end view of a portion of the receptacle of FIGS. 2 and 3 in a fully-assembled state showing the locking tab inserted around fold edges of respective corner flaps and disposed between the corner flaps and an end wall;

FIG. 5 is a pre-assembly view of another embodiment of a sheet of foldable material for assembling into a receptacle in accordance with the instant invention;

FIG. 6 is a partially disassembled view of a portion of a receptacle formed from the sheet of FIG. 5, focusing on a locking tab thereof and showing the locking tab folding in a direction toward the corner flaps; and

FIG. 7 is an inside end view of a portion of the receptacle of FIGS. 5 and 6 in a fully-assembled state showing the locking tab folded toward the corner flaps, inserted around fold edges of the respective corner flaps, and disposed between the corner flaps and an end wall.

### DESCRIPTION OF THE INVENTION

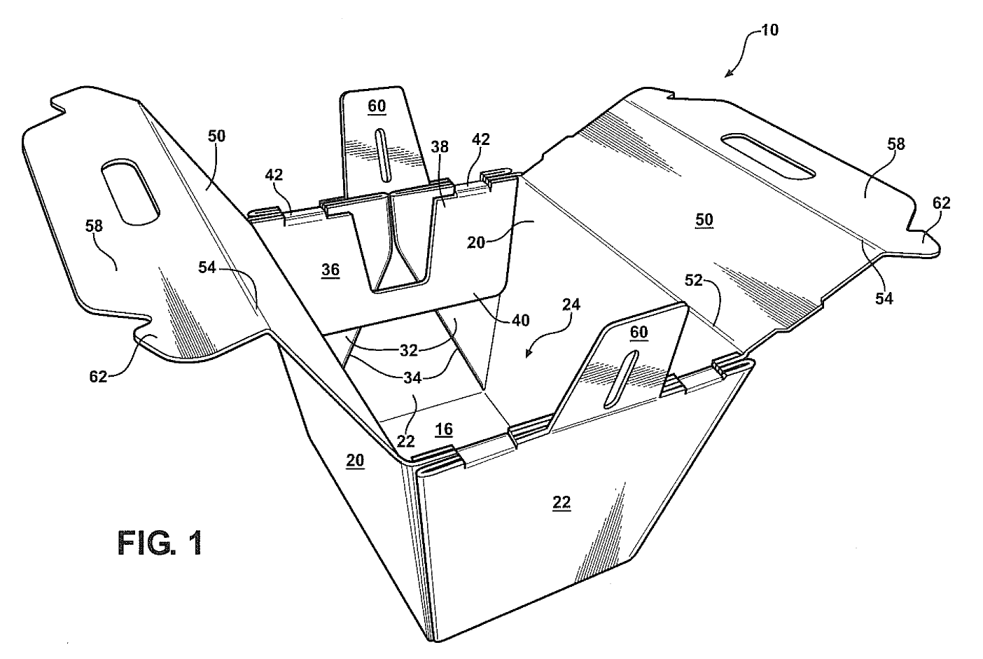

Referring to the Figures, wherein like numerals are used to designate like structures, a receptacle is shown generally at 10 in FIG. 1. The receptacle 10 can be used as a cooler to store and cool food and beverages in conjunction with ice or ice packs. However, it is to be appreciated that the receptacle 10 is not limited to use as a cooler and can be used for storage and/or transportation of various types of articles such as personal items and various types of food such as meat, fruits, or vegetables.

The receptacle 10 is assembled from a sheet of foldable material 12. Typically, the sheet of foldable material 12 is further defined as a sheet of fibrous material. For example, the sheet of fibrous material may be a sheet of corrugated paperboard. As known in the art, corrugated paperboard comprises a fluted corrugated sheet sandwiched between two flat linerboards. The receptacles 10 assembled from corrugated paperboard provide many benefits, especially when the receptacles 10 are used as coolers. For example, the corrugated paperboard receptacles 10 present significant environmental benefits over traditional styrofoam coolers due to the fact that corrugated paperboard has a drastically shorter environmental degradation period as compared to styrofoam. Further, the corrugated paperboard receptacles 10 are more robust and more easily transportable as compared to traditional styrofoam coolers. However, it is to be appreciated that the instant invention is not limited to receptacles 10 assembled from corrugated paperboard, and that any foldable material 12 that is capable of being assembled into the receptacle 10 as described herein can be used.

The sheet of foldable material 12 may be subject to treatment for purposes of enhancing water resistance of the foldable material 12, especially when the foldable material 12 is the fibrous material such as corrugated paperboard and especially when the receptacle 10 is intended to be used for retaining wet or moist contents such as when the receptacle 10 is to be used as a cooler. For example, a waxy coating (not shown) may be applied to and/or infused into the sheet of foldable material 12 (or the various layers of the corrugated paperboard when used as the sheet of foldable material 12).

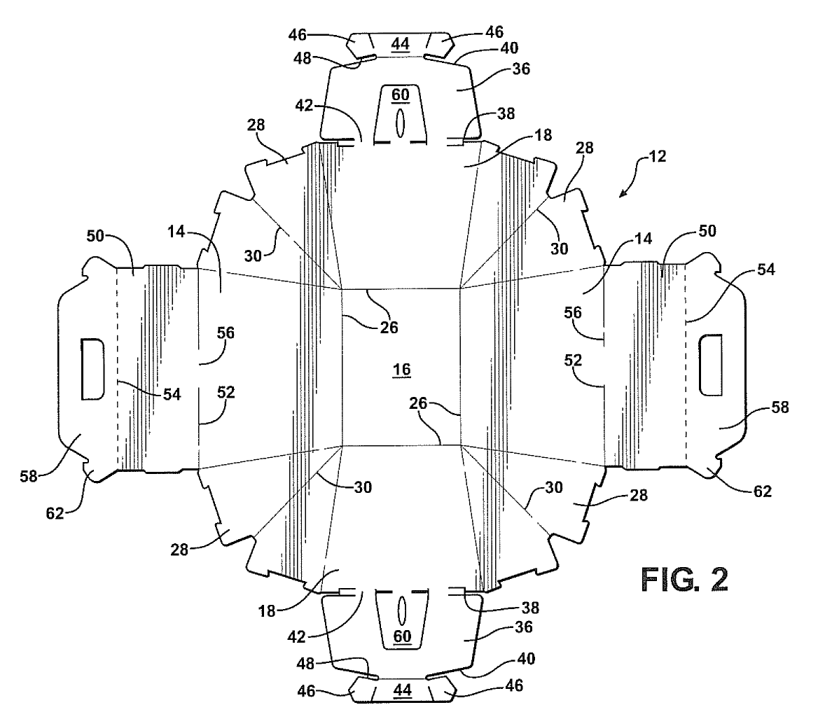

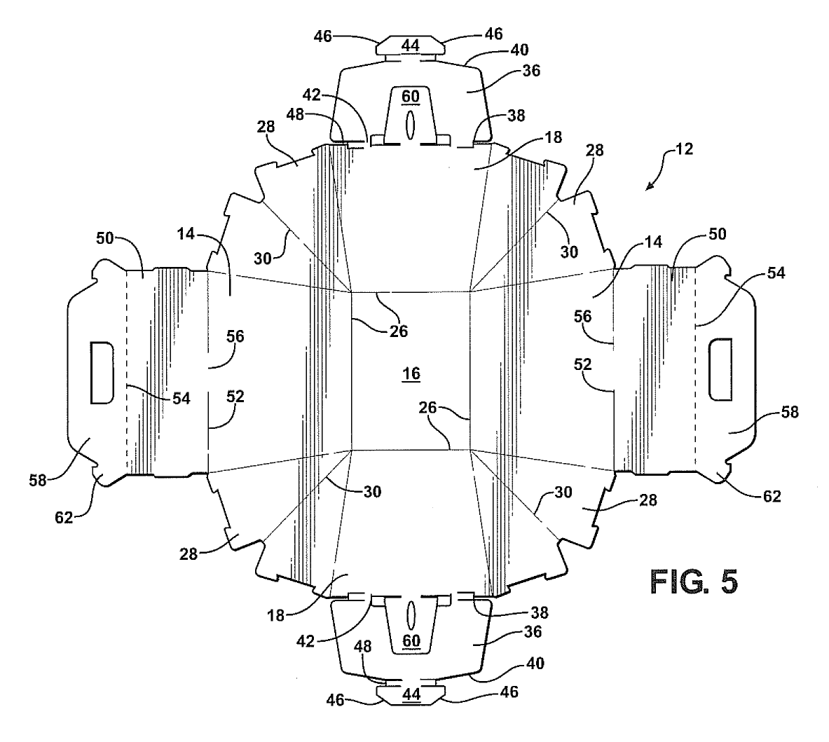

Typically, as shown in FIGS. 2 and 5, a single sheet of foldable material 12 is used to assemble the receptacle 10. The single sheet of foldable material 12 may be particularly beneficial when the receptacle 10 is used as a cooler, especially because seams, perforations, and other features that may otherwise enable liquids to escape from the receptacle 10 may be minimized and, in some cases, eliminated. However, it is to be appreciated that the instant invention is not limited to a receptacle 10 that is assembled from a single sheet of foldable material 12, and it may be possible to form various portions of the receptacle 10 from separate sheets of foldable material 12. For example, in one embodiment (not shown), a separate cover may be assembled from one sheet of material, while a bottom, side walls 20, and end walls 22 of the receptacle may be formed assembled from another sheet of material.

Referring to FIGS. 2 and 5, the sheet of foldable material 12 comprises a pair of side wall panels 14 that are disposed opposite to each other across a bottom panel 16. The sheet of foldable material 12 also comprises a pair of end wall panels 18 that are disposed opposite to each other across the bottom panel 16. Typically, the end wall panels 18 are shorter in width as compared to the side wall panels 14; however, it is to be appreciated that in various embodiments the side wall panels 14 may be shorter or equal in width as compared to the end wall panels 18. As shown in FIGS. 1, 3, 4, 6, and 7, the side wall panels 14 and the end wall panels 18 are foldable into respective side walls 20 and end walls 22 of the receptacle 10. The resulting end walls 22 are disposed opposite to each other and extend between the respective side walls 20, which are also disposed opposite to each other, after folding of the side wall panels 14 and end wall panels 18. The side walls 20, end walls 22, and bottom panel 16 of the resulting receptacle 10 define an interior 24 of the receptacle 10. Bottom panel fold lines 26 demark a boundary between the bottom panel 16 and the end wall panels 18 and side wall panels 14. The bottom panel fold lines 26, like most of the fold lines described herein, are observable as depressions in the sheet of foldable material 12 and are typically free of perforations or cuts that expose inner portions of the sheet of foldable material 12. More specifically, the side walls 20 and end walls 22 are defined by either a cut edge or edges, or by fold seams that are integral with other portions of the sheet of foldable material 12. In this regard, the side wall panels 14, end wall panels 18, and bottom panel 16 are typically free from perforations in general, the benefits of which are described in further detail below.

As shown in FIGS. 2 and 5, the sheet of foldable material 12 further comprises a pair of collapsible corner flap panels 28 that adjoin one of the end wall panels 18 to the side wall panels 14 adjacent thereto. More specifically, one collapsible corner flap panel 28 of the pair of collapsible corner flap panels 28 is disposed between the end wall panel 18 and the respective side wall panels 14. Typically, the sheet of foldable material 12 comprises collapsible corner flap panels 28 that adjoin each of the end wall panels 18 to the side wall panels 14 adjacent thereto, i.e., collapsible corner flap panels 28 are disposed between each end wall panel 18 and the respective side wall panels 14. However, it is to be appreciated that for the purposes of the instant invention, the sheet of foldable material 12 may be configured such that only one of the end wall panels 18 is connected to the respective side wall panels 14 through the respective collapsible corner flap panels 28. The collapsible corner flap panels 28 are collapsible and foldable along a fold line 30. As with the bottom panel 16 fold lines, the fold lines 30 are also typically observable as depressions in the sheet of foldable material 12 and are typically free of perforations or cuts that expose inner portions of the sheet of foldable material 12. After collapsing, resulting corner flaps 32 in the receptacle 10 extend toward each other into the interior 24 of the receptacle 10 with the corner flaps 32 defining a fold edge 34 along the fold line 30. In the resulting receptacle 10, each collapsible corner flap 32 adjoins the end wall 22 to the side wall 20 adjacent thereto, thereby effectively sealing the interior 24 of the receptacle 10 along a corner between the end wall 22 and side wall 20. Because the fold lines 30 are typically free of perforations or cuts that expose inner portions of the sheet of foldable material 12, the interior 24 of the resulting receptacle 10 is suitable for retaining wet or moist contents while inhibiting leaking or migration of the liquids out of the interior 24 of the receptacle 10 and into inner portions of the sheet of foldable material 12 (or out of the receptacle 10 altogether).

The sheet of foldable material 12 further comprises a folding flap 36 that has a first end 38 and a second end 40. The first end 38 of the folding flap 36 is attached to the end wall panel 18 and the second end 40 of the folding flap 36 is disposed opposite the first end 38 and free from attachment to the end wall panels 18 and side wall panels 14. In this manner, the folding flap 36 is free to hinge about the attachment point 42 to the end wall 22. Typically, folding flaps 36 are attached to each end wall panel 18. However, it is to be appreciated that for the purposes of the instant invention, the sheet of foldable material 12 may be configured such that only one of the end wall panels 18 includes the folding flap 36 attached thereto. When the receptacle 10 is assembled, the pair of corner flaps 32 are held by the folding flap 36 against the respective end wall 22 that is adjacent to the respective corner flaps 32. The folding flap 36 is folded over the pair of corner flaps 32 to secure the corner flaps 32 between the folding flap 36 and the end wall 22. As such, the corner flaps 32 are impeded from unfolding due to the interaction between the folding flap 36 and the corner flaps 32.

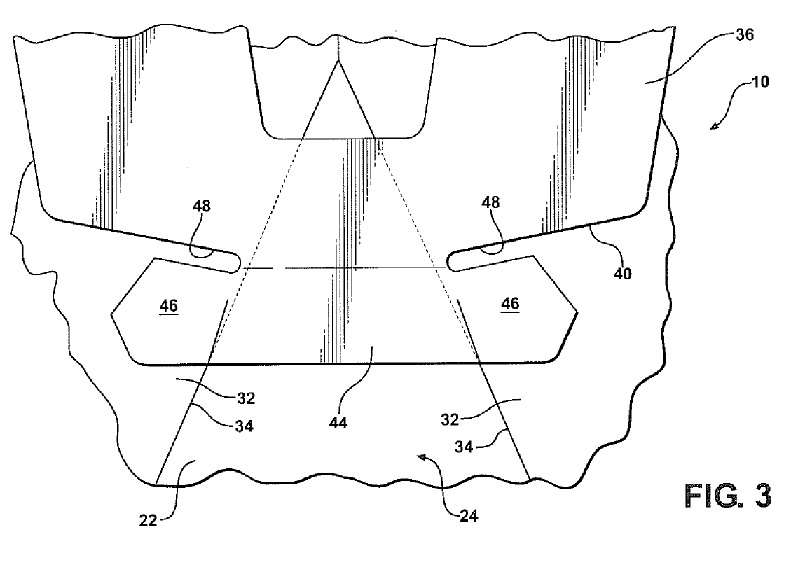

After assembly of the receptacle 10, the folding flap 36 may be subject to rotational force about the attachment point 42 between the folding flap 36 and the end wall 22. Further, the corner flaps 32 have a natural tendency to unfold, thereby exerting force on the folding flap 36. For purposes of securing the folding flap 36 in place, the folding flap 36 includes a locking tab 44. As set forth above, folding flaps 36 are typically attached to each end wall panel 18, in which case each folding flap 36 includes the locking tab 44. The locking tab 44 is disposed on a portion thereof that, upon folding of the corner flap panels 28, side wall panels 14, and end wall panels 18, is adjacent to the fold edge 34 of at least one of the resulting corner flaps 32. More specifically, as shown in FIGS. 3, 4, 6, and 7, the folding flap 36 includes the locking tab 44 on the portion thereof that is adjacent to the fold edge 34 of at least one of the resulting corner flaps 32 when the folding flap 36 is overlying the corner flaps 32. Typically, the locking tab 44 is included on the folding flap 36 adjacent to fold edges 34 of both of the corner flaps 32 for purposes to be described in further detail below. In various embodiments, as shown in FIGS. 2-6, the locking tab 44 extends from the second end 40 of the folding flap 36. However, it is to be appreciated that the locking tab 44 may be disposed on any portion of the folding flap 36 that places the locking tab 44 adjacent to the fold edge 34 of at least one of the corner flaps 32 when the folding flap 36 is overlying the corner flaps 32.

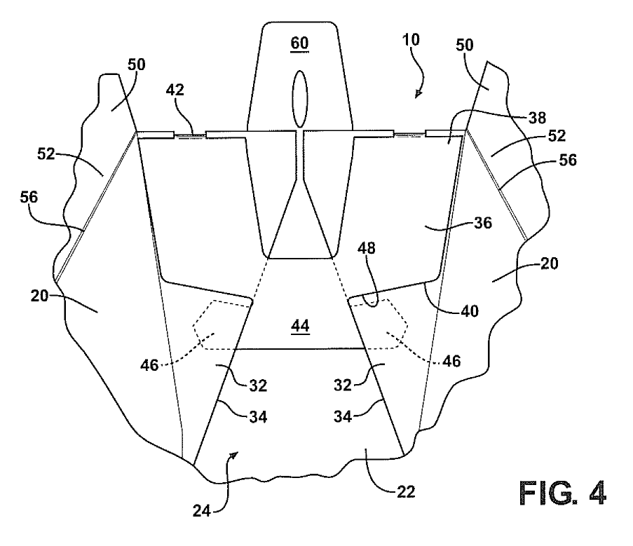

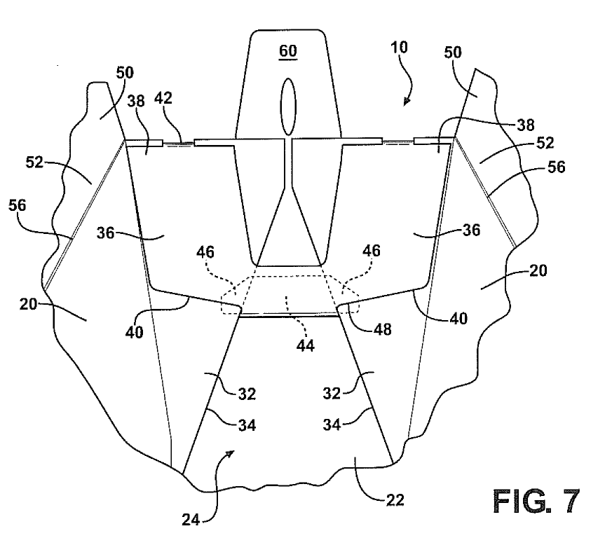

The locking tab 44 is insertable around the fold edge 34 and between the at least one corner flap 32 and the end wall 22. As set forth above, the locking tab 44 is typically included on the folding flap 36 adjacent to fold edges 34 of both of the corner flaps 32, in which case the locking tab 44 is insertable around each of the fold edges 34 and between each corner flap 32 and the end wall 22 to provide a more robust connection between the folding flap 36 and the corner flaps 32. As such, in the assembled receptacle 10, the locking tab 44 is inserted around the fold edge 34 and between the at least one corner flap 32 and the end wall 22. In this regard, no perforations or slots in the sheet of foldable material 12 are necessary for purposes of receiving the locking tab 44 and/or for purposes of securing the locking tab 44 in place. Rather, as shown in FIGS. 4 and 7, the locking tab 44 exploits the presence of the structure in the assembled receptacle 10, e.g., the corner flaps 32 that include the fold edge 34, to provide a mechanical feature that prevents unfolding of the paperboard receptacle 10 without relying upon slots cut through the sheet of foldable material 12.

To enable the locking tab 44 to be insertable around the fold edge 34 and between the at least one corner flap 32 and the end wall 22, the locking tab 44 typically has at least one finger 46, which effectively enables the locking tab 44 to sandwich the corner flap 32 with the folding flap 36 while the finger 46 of the locking tab 44 itself is sandwiched between the corner flap 32 and the end wall 22. When the locking tab 44 is included on the folding flap 36 adjacent to fold edges 34 of both of the corner flaps 32, and when the locking tab 44 is insertable around each of the fold edges 34 and between each corner flap 32 and the end wall 22, the locking tab 44 may include two fingers 46 with one finger 46 insertable around each of the fold edges 34 and between each corner flap 32 and the end wall 22. When the locking tab 44 extends from the second end 40 of the folding flap 36, the finger(s) 46 may be defined by a cutout 48 along the second end 40 of the folding flap 36 between the locking tab 44 and the folding flap 36.

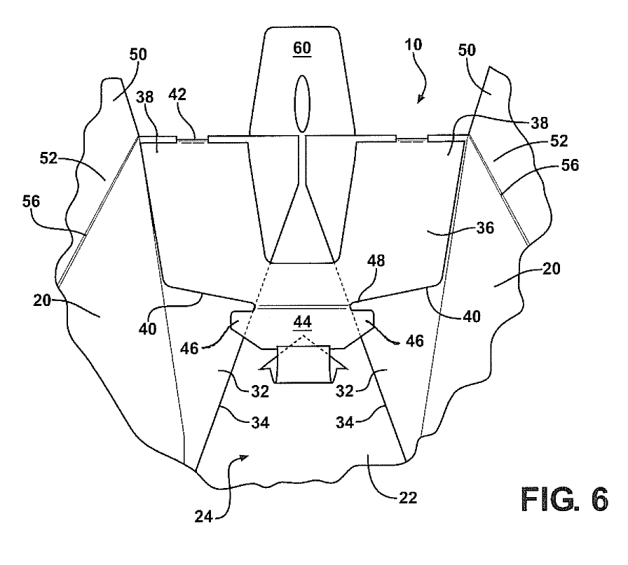

In one embodiment, as shown in FIGS. 3 and 4, the fingers 46 are simply inserted around the fold edge(s) 34 to secure the folding flap 36 in place. In another embodiment, as shown in FIGS. 6 and 7, the locking tab 44 is folded in a direction towards the corner flaps 32, with the finger 46 inserted around the fold edge(s) 34 and between the respective corner flap 32 and end wall 22. In this embodiment, as shown particularly in FIG. 7, the locking tab 44 is rotated about 180 degrees from an initial position, which may provide benefits when the receptacle 10 is used as a cooler due to the fact that the locking tab 44 is disposed further from the bottom panel 16 of the receptacle 10 once assembled and, thus, further away from any liquid that may be present in the receptacle 10 and that may otherwise be more easily prone to flowing into the inner portions of the sheet of foldable material 12 through cut edges of the locking tab 44.

The sheet of foldable material 12 may have additional features including integral cover flaps 50. The integral cover flaps 50 have a first end 52 and a second end 54 with the first end 52 of the cover flaps 50 attached to respective side wall panels 14 and the second end 54 of the cover flaps 50 disposed opposite the first end 52 and free from attachment to the side wall panels 14 and end wall panels 18. In this manner, the cover flaps 50 are free to hinge about an attachment point 56 to the respective side walls 20. Handle flaps 58 may be attached to the cover flaps 50 at the second end 54 of the cover flaps 50, with the handle flaps 58 abutting each other on a surface thereof when the cover flaps 50 are rotated so as to close the receptacle 10. Additionally, locking flaps 60 may be attached to the respective end walls 22 and may be used in conjunction with a projection 62 on the handle flaps 58 to effectively lock the cover flaps 50 and handle flaps 58 in a “closed” position.

To assemble the receptacle 10 from the sheet of foldable material 12, the side wall panels 14 and end wall panels 18 are folded into respective side walls 20 and end walls 22 of the receptacle 10 with the resulting end walls 22 extending between the respective side walls 20 to define an interior 24 of the receptacle 10. The corner flap panels 28 that adjoin the end wall panels 18 to the side wall panels 14 adjacent thereto are collapsed along the fold line 30 with the resulting corner flaps 32 extending toward each other into the interior 24 of the receptacle 10 and with the corner flaps 32 defining the fold edge 34 along the fold line 30. The folding flap 36 is then folded over the corner flaps 32 with the corner flaps 32 disposed between the folding flap 36 and the end wall 22 adjacent to the respective corner flaps 32. The locking tab 44 is then inserted around the fold edge 34 and between the at least one corner flap 32 and the end wall 22 to thereby secure the folding flap 36 in place. In one embodiment, as alluded to above and as shown in FIG. 6, the locking tab 44 is folded in a direction toward the corner flaps 32, with the resulting locking tab 44 rotated about 180 degrees from an initial position. The receptacle 10 can be disassembled by removing the locking tab 44 (in particular, the fingers(s) 46 of the locking tab 44) from between the respective corner flap 32 and end wall 22, thereby allowing the folding flap 36 to pivot out of engagement with the corner flaps 32.

The invention has been described in an illustrative manner, and it is to be appreciated that the terminology which has been used is intended to be in the nature of words of description rather than of limitation. Obviously, many modifications and variations of the present invention are possible in view of the above teachings. It is, therefore, to be appreciated that within the scope of the claims the invention may be practiced otherwise than as specifically described, and that the reference numerals are merely for convenience and are not to be in any way limiting.

What is claimed is:

1. A receptacle assembled from a sheet of foldable material, said receptacle comprising:
a pair of side walls disposed opposite to each other;
a pair of end walls disposed opposite to each other and extending between said respective side walls to define an interior of said receptacle;
a pair of collapsible corner flaps adjoining one of said end walls to said side walls adjacent thereto, said corner flaps collapsed and folded along a fold line and extending toward each other into the interior of said receptacle with said corner flaps defining a fold edge along said fold line;
a folding flap having a first end and a second end, said first end attached to said end wall and said second end disposed opposite said first end and free from attachment to said end wall and side walls;
wherein said corner flaps are held against said end wall adjacent to said respective corner flaps and wherein said folding flap is folded over said corner flaps with said corner flaps disposed between said folding flap and said end wall;
said folding flap including a locking tab on a portion thereof adjacent to said fold edge of at least one of said corner flaps with said locking tab inserted around said fold edge and between said at least one corner flap and said end wall.

2. A receptacle as set forth in claim 1 wherein collapsible corner flaps adjoin each of said end walls to said side walls adjacent thereto, with folding flaps attached to each end wall, with said corner flaps held against said respective end wall adjacent to said respective corner flaps, and with each folding flap folded over said respective corner flaps to secure said corner flaps between said respective folding flap and said respective end wall.

3. A receptacle as set forth in claim 1 wherein said locking tab is included on said folding flap adjacent to fold edges of both of said corner flaps with said locking tab inserted around each of said fold edges and between each corner flap and said end wall.

4. A receptacle as set forth in claim 1 wherein said locking tab extends from said second end of said folding flap.

5. A receptacle as set forth in claim 4 wherein said locking tab has at least one finger defined by a cutout along said second end of said folding flap between said locking tab and said folding flap with said finger of said locking tab inserted around said fold edge and between said at least one corner flap and said end wall.

6. A receptacle as set forth in claim 5 wherein said locking tab is folded in a direction towards said corner flaps, with said finger inserted around said fold edge and between said respective corner flap and end wall.

7. A receptacle as set forth in claim 1 wherein said side walls and said end walls are free from perforations.

8. A receptacle as set forth in claim 1 wherein said sheet of foldable material is further defined as a single sheet of foldable material.

9. A receptacle as set forth in claim 1 wherein said sheet of foldable material is further defined as a sheet of fibrous material.

10. A sheet of foldable material for assembling into a receptacle, said sheet of foldable material comprising:
a pair of side wall panels disposed opposite to each other across a bottom panel;
a pair of end wall panels disposed opposite to each other across said bottom panel with said side wall panels and said end wall panels foldable into respective side walls and end walls of the receptacle and with the resulting end walls extending between the respective side walls to define an interior of the receptacle;
a pair of collapsible corner flap panels adjoining one of said end wall panels to said side wall panels adjacent thereto, said corner flap panels collapsible and foldable along a fold line with resulting corner flaps extending toward each other into the interior of the receptacle with the corner flaps defining a fold edge along said fold line after the corner flap panels are collapsed;
a folding flap having a first end and a second end, said first end attached to said end wall panel and said second end disposed opposite said first end and free from attachment to said end wall panels and side wall panels;
said folding flap including a locking tab on a portion thereof that, upon folding of said corner flap panels, side wall panels, and end wall panels, is adjacent to the fold edge of at least one of the resulting corner flaps with said locking tab insertable around the fold edge and between the at least one corner flap and the end wall.

11. A sheet of foldable material as set forth in claim 10 wherein collapsible corner flap panels adjoin each of said end wall panels to said side wall panels adjacent thereto, with folding flaps attached to each end wall panel.

12. A sheet of foldable material as set forth in claim 10 wherein said locking tab is included on said folding flap on the portion thereof that, upon folding of said corner flap panels, side wall panels, and end wall panels, is adjacent to the fold edges of both of the corner flaps with said locking tab insertable around each of the fold edges and between each corner flap and the end wall.

13. A sheet of foldable material as set forth in claim 10 wherein said locking tab extends from said second end of said folding flap.

14. A sheet of foldable material as set forth in claim 13 wherein said locking tab has at least one finger defined by a cutout along said second end of said folding flap between said locking tab and said folding flap with said finger of said locking tab insertable around the fold edge and between the at least one corner flap and the end wall.

15. A sheet of foldable material as set forth in claim 10 wherein said side wall panels and said end wall panels are free from perforations.

16. A sheet of foldable material as set forth in claim 10 further defined as a single sheet of foldable material.

17. A sheet of foldable material as set forth in claim 10 further defined as a sheet of fibrous material.

18. A sheet of foldable material as set forth in claim 17 further defined as a sheet of corrugated paperboard comprising a fluted corrugated sheet sandwiched between two flat linerboards.

19. A method of assembling a receptacle from the sheet of foldable material set forth in claim 10, said method comprising the steps of:
folding the side wall panels and end wall panels into respective side walls and end walls of the receptacle with the resulting end walls extending between the respective side walls to define an interior of the receptacle;
collapsing the pair of corner flap panels that adjoin at least one of the end wall panels to the side wall panels adjacent thereto along the fold line with resulting corner flaps extending toward each other into the interior of the receptacle and with the corner flaps defining the fold edge along the fold line;
folding the folding flap over the corner flaps with the corner flaps disposed between the folding flap and the end wall adjacent to the respective corner flaps; and
inserting the locking tab around the fold edge and between the at least one corner flap and the end wall.

20. A method as set forth in claim 19 further comprising the step of folding the locking tab in a direction toward the corner flaps.
